(19) United States
(12) Patent Application Publication
(10) Pub. No.: US 2025/0292122 A1
(43) Pub. Date: Sep. 18, 2025

(54) APPARATUS AND METHOD FOR DISTRIBUTED MULTI-AGENT REINFORCEMENT LEARNING

(71) Applicant: ELECTRONICS AND TELECOMMUNICATIONS RESEARCH INSTITUTE, Daejeon (KR)

(72) Inventors: Young-Hwan SHIN, Daejeon (KR); Sung-Won YI, Daejeon (KR); Hyun-Woo KIM, Daejeon (KR); Seung-Woo SEO, Daejeon (KR); Hwa-Jeon SONG, Daejeon (KR); Jeong-Min YANG, Daejeon (KR); Byung-Hyun YOO, Daejeon (KR); Eui-Sok CHUNG, Daejeon (KR)

(73) Assignee: ELECTRONICS AND TELECOMMUNICATIONS RESEARCH INSTITUTE, Daejeon (KR)

(21) Appl. No.: 19/080,020

(22) Filed: Mar. 14, 2025

(30) Foreign Application Priority Data
Mar. 15, 2024 (KR) 10-2024-0036653

(51) Int. Cl. G06N 5/043; G06N 20/00

(52) U.S. Cl. CPC G06N 5/043; G06N 20/00

(57) ABSTRACT

Disclosed herein is an apparatus and method for distributed multi-agent reinforcement learning. The method may include exploring a skew parameter at which a skewed Jensen-Shannon-(JS-)divergence, which is a change in a policy, becomes equal to or greater than a preassigned maximum value of a skewed JS-divergence stationarity and performing training based on a target policy set using the skew parameter.

### CROSS REFERENCE TO RELATED APPLICATION

This application claims the benefit of Korean Patent Application No. 10-2024-0036653, filed Mar. 15, 2024, which is hereby incorporated by reference in its entirety into this application.

### BACKGROUND OF THE INVENTION

### 1. Technical Field

The disclosed embodiment relates to technology for multi-agent reinforcement learning.

### 2. Description of the Related Art

In most multi-agent reinforcement learning studies, multi-agent reinforcement learning algorithms are configured based on a Centralized Training with Decentralized Execution (CTDE) mechanism that uses observation information or training information of all agents during a training process of the algorithm but uses only observation and training information of each agent itself to perform execution during an execution process.

The CTDE method, which shares information of the agents, is an efficient training method, but it is often difficult to apply this method in the real world. For example, in a military environment in which the security of each agent is important, in the case in which individuals refuse to share information due to privacy concerns, or in the case in which it is difficult for autonomous vehicles on the road to share information with each other because the autonomous vehicles are manufactured by different companies, it is difficult to apply the CTDE method. In this case, there is no choice but to use a Decentralized Training with Decentralized Execution (DTDE) method.

However, there are two inherent problems within the DTDE environment. One of the problems is the low learning speed. All agents are required to carry out various observations because they do not share observation information with each other. Also, the agents cannot share training information because they do not share parameters. This means that the number of parameters increases with an increase in the number of agents. Therefore, the learning speed of the DTDE is generally lower than that of the CTDE.

The bigger problem with the DTDE is a non-stationarity problem. The theory of reinforcement learning is based on the Markovian assumption. Agents observe the past action of other agents and stochastically predict the subsequent action based on the Markovian assumption. However, if the respective agents change the pattern of actions during learning, the Markovian assumption collapses. This phenomenon is called the non-stationarity problem. When the non-stationarity problem becomes severe, learning does not progress well.

In Independent Q-Learning (IQL), Independent synchronous Advantage Actor-Critic (IA2C), and Independent Proximal Policy Optimization (IPPO) proposed early in multi-agent reinforcement learning research, each agent uses an algorithm developed in a single-agent environment. Therefore, they also have the above-described problem with the DTDE. The way to mitigate the non-stationarity problem in these basic algorithms is to reduce the span of the policy update of the agent. Reducing the span of the update may alleviate the non-stationarity problem, but may further slow down the already slow training speed of the DTDE framework. Therefore, considering both the training speed and the non-stationarity problem, it is ideal to moderately adjust the span of the update. However, non-quantitative adjustment inevitably relies only on intuition of researchers.

### SUMMARY OF THE INVENTION

An object of the disclosed embodiment is to quantify the degree of non-stationarity that occurs in an environment during distributed agent training and to adjust the amount of training of each agent depending on the degree of occurrence of the non-stationarity.

Another object of the disclosed embodiment is to quantify non-stationarity and provide a method of updating the policy of an agent without exceeding a certain amount of non-stationarity.

A method for distributed multi-agent reinforcement learning according to an embodiment may include exploring a skew parameter at which a skewed Jensen-Shannon-(JS-)divergence, which is a change in a policy, becomes equal to or greater than a preassigned maximum value of a skewed JS-divergence stationarity and performing training based on a target policy set using the skew parameter.

Here, a value equal to or less than the maximum value of a stationarity that is the sum of skewed JS-divergences, each of which is a change in a policy of each of multiple agents, may be preassigned as the maximum value of the skewed JS-divergence stationarity.

Here, the method may further include, before exploring the skew parameter, initializing a policy parameter of an agent.

Here, exploring the skew parameter may include setting an initial skew parameter αᵢ (i being an identifier of an agent) based on the maximum value of the skewed JS-divergence stationarity.

Here, when exploring the skew parameter, storing experience using a current policy, performing stochastic policy training based on the stored experience, and calculating a skewed DS-divergence from a previous policy using the skew parameter αᵢ may be performed, and calculating the skewed JS-divergence while changing the skew parameter αᵢ may be repeatedly performed until the skewed JS-divergence becomes equal to or greater than the maximum value of the skewed JS-divergence stationarity.

Here, performing the training may include, when the skewed JS-divergence is equal to or greater than the maximum value of the skewed JS-divergence stationarity, setting the target policy through interpolation between an actually trained policy and the previous policy using the skew parameter αᵢ.

Here, performing the training may comprise performing the training such that a policy parameter of the agent approximates to the target policy by setting a loss function to a JS-divergence between the current policy and the target policy.

Here, exploring the skew parameter and performing the training may be repeatedly performed a predetermined number of times.

An apparatus for distributed multi-agent reinforcement learning according to an embodiment includes memory in which at least one program is recorded and a processor for executing the program. The program may perform exploring a skew parameter at which a skewed JS-divergence, which is a change in a policy, becomes equal to or greater than a preassigned maximum value of a skewed JS-divergence stationarity and performing training based on a target policy set using the skew parameter.

Here, a value equal to or less than a maximum value of a stationarity that is the sum of skewed JS-divergences, each of which is a change in a policy of each of multiple agents, may be preassigned as the maximum value of the skewed JS-divergence stationarity.

Here, the program may further perform initializing a policy parameter of an agent before exploring the skew parameter.

Here, when exploring the skew parameter, the program may perform setting an initial skew parameter αᵢ (i being an identifier of an agent) based on the maximum value of the skewed JS-divergence stationarity.

Here, when exploring the skew parameter, the program may perform storing experience using a current policy, performing stochastic policy training based on the stored experience, and calculating a skewed DS-divergence from a previous policy using the skew parameter αᵢ, and may repeatedly perform calculating the skewed JS-divergence while changing the skew parameter αᵢ until the skewed JS-divergence becomes equal to or greater than the maximum value of the skewed JS-divergence stationarity.

Here, when performing the training, the program may perform setting the target policy through interpolation between an actually trained policy and the previous policy using the skew parameter a; when the skewed JS-divergence is equal to or greater than the maximum value of the skewed JS-divergence stationarity.

Here, when performing the training, the program may perform the training such that a policy parameter of the agent approximates to the target policy by setting a loss function to a JS-divergence between the current policy and the target policy.

Here, the program may repeatedly perform exploring the skew parameter and performing the training a predetermined number of times.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a flowchart for explaining a method for multi-agent reinforcement learning according to an embodiment;

FIG. 2 is a detailed flowchart for explaining a step of exploring a skew parameter according to an embodiment;

FIG. 3 is a detailed flowchart for explaining a step of performing training based on a target policy according to an embodiment; and

FIG. 4 is a view illustrating a computer system configuration according to an embodiment.

### DESCRIPTION OF THE PREFERRED EMBODIMENTS

The advantages and features of the present disclosure and methods of achieving them will be apparent from the following exemplary embodiments to be described in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

When agents are trained in a distributed manner in a multi-agent reinforcement learning environment, a non-stationarity problem is caused. Specifically, when it is intended to solve the problem by applying general policy-gradient-based algorithms, i.e., IPPO or IA2C, each agent may not be properly trained because it faces the non-stationarity problem.

In the disclosed embodiment, in order to solve this problem, the non-stationarity of a change in a policy of each agent is measured through JS-stationarity developed using skewed Jensen-Shannon-(JS-)divergence, whereby the non-stationarity resulting from the change in the policy of the agent is quantified. Subsequently, the span of the policy update of the agent is adjusted to be equal to or less than a certain JS-stationarity value.

In order to solve this problem, the present disclosure proposes a JS-stationarity technique capable of mathematically quantifying a change in the non-stationarity depending on the update span of the agent. Also, the present disclosure proposes JS-update, which adjusts the update span of each agent based on the JS-stationarity.

The underlying technology behind JS-stationarity and JS-update is the skewed JS-divergence. In order to describe the skewed JS-divergence, it is necessary to describe the Kullback-Leibler (KL) divergence and the JS divergence first, so the KL divergence, the JL divergence, the skewed KL-divergence, and the skewed JS-divergence will be described in the order in which they are listed.

When general probability distributions P and Q are defined in the same sample space X, the KL divergence D_{KL} is defined as shown in Equation (1) below:

$$Discrete form {D}_{K L} ( P ‖ Q ) = - {\sum }_{x ∈ X} P ( x ) log ( \frac{Q ( x )}{P ( x )} ) \qquad ( 1 )$$

$$Continuous form {D}_{K L} ( P ‖ Q ) = - {\int }_{- ∞}^{∞} p ( x ) log ( \frac{q ( x )}{p ( x )} ) d x$$

In Equation (1), p and q are the probability density functions of P and Q, respectively. When general probability distributions P and Q are present, the JS divergence D_{JS}(P∥Q) is defined as shown in Equation (2) below:

$${D}_{JS} ( P ‖ Q ) = \frac{1}{2} {D}_{K L} ( P ‖ M ) + \frac{1}{2} {D}_{K L} ( Q ‖ M ) \qquad ( 2 )$$

In Equation (2), the probability distribution M is defined as the average of the two probability distributions P and Q, as shown in Equation (3) below:

$$M = \frac{1}{2} ( P + Q ) \qquad ( 3 )$$

The skewed KL-divergence is one type of the KL divergence and indicates the KL divergence that is biased towards a corresponding probability by α. Here, the skewed KL divergence is defined as shown in Equation (4) below:

$${D}_{K L}^{α} ( P ‖ Q ) = {D}_{K L} ( P ‖ ( 1 - α ) P + α Q ) , 0 \leq α \leq 1 \qquad ( 4 )$$

The skewed JS divergence is one type of the JS divergence and indicates the JS divergence that is biased to a corresponding probability by α. Here, the skewed JS-divergence, D_{JS}^{α}(P∥Q), is defined as shown in Equation (5) below:

$${D}_{JS}^{α} ( P ‖ Q ) = \frac{1}{2} ( {D}_{K L}^{α} ( P ‖ Q ) + {D}_{K L}^{α} ( Q ‖ P ) ) \qquad ( 5 )$$

Referring to Equation (4) of the skewed KL-divergence, the two probability distributions P and Q are interpolated by α. Accordingly, the distance between P and the distribution interpolated between the two probability distributions can be seen. This is the same in Equation (5) of the skewed JS-divergence.

In an embodiment, the skewed JS-divergence may be applied to multi-agent reinforcement learning.

When a policy of an agent at the time of t is πₜ, the policy after completion of one stage of training may be defined as πₜ₊₁. When these two probability distributions are applied to the skewed JS-divergence, it may be defined as shown in Equation (6) below:

$${D}_{JS}^{α} ( {π}_{t} ‖ {π}_{t + 1} ) = \frac{1}{2} ( {D}_{K L}^{α} ( {π}_{t} ‖ {π}_{t + 1} ) + {D}_{K L}^{α} ( {π}_{t + 1} ‖ {π}_{t} ) ) \qquad ( 6 )$$

In Equation (6), the JS divergence value is set depending on the value of α. That is, when α is 1, the JS divergence value becomes the maximum, and when α is 0, the JS divergence value becomes the minimum. This means that the JS divergence value may be adjusted by adjusting the value of α.

In an embodiment, an apparatus and method for mitigating non-stationarity by readjusting the update span of agents that use an algorithm based on a stochastic policy in a DTDE multi-agent reinforcement learning environment are proposed.

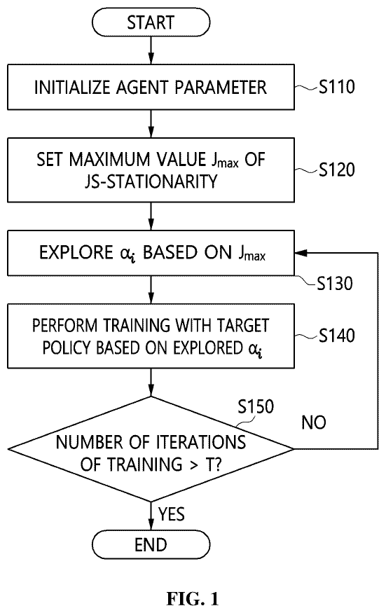

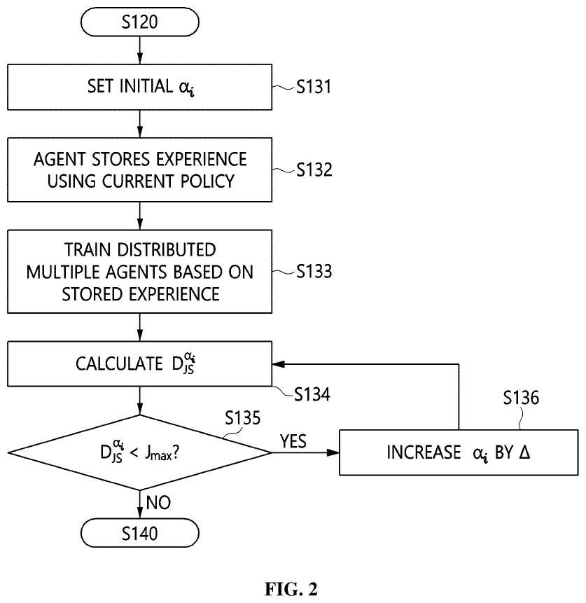

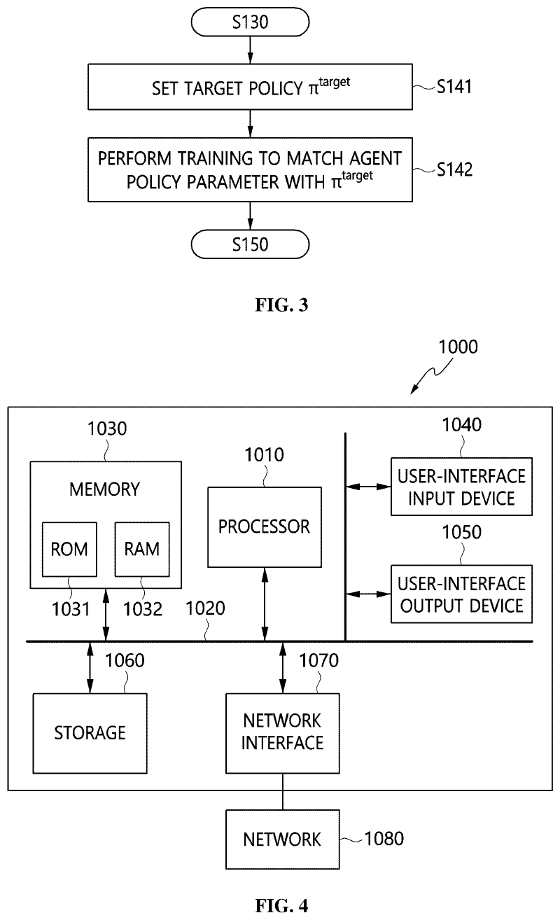

FIG. 1 is a flowchart for explaining a method for multi-agent reinforcement learning according to an embodiment, FIG. 2 is a detailed flowchart for explaining a step of exploring a skew parameter according to an embodiment, and FIG. 3 is a detailed flowchart for explaining a step of performing training based on a target policy according to an embodiment.

In an embodiment, an example in which an algorithm using a policy gradient is applied will be described for helping the understanding of the disclosure. However, this is merely an example, and the present disclosure is not limited thereto. That is, the embodiment may be applied to any algorithm that uses a stochastic policy as well as an algorithm based on the policy gradient.

Many of the algorithms using the policy gradient have an actor-critic structure that uses the critic together, but a critic update process will be omitted because the present disclosure can be applied regardless of the use of the critic.

Referring to FIG. 1, the method for distributed multi-agent reinforcement learning according to embodiment may include exploring a skew parameter at which the skewed JS-divergence, which is a change in a policy, becomes equal to or greater than a preassigned maximum value of a skewed JS-divergence stationarity at step S130 and performing training at step S140 based on a target policy set using the skew parameter. The method for distributed multi-agent reinforcement learning may be individually performed in each of multiple agents that are distributed. The method for distributed multi-agent reinforcement learning according to an embodiment may further include initializing the policy parameter of the agent at step S110 before exploring the skew parameter.

That is, in an embodiment, when the first training begins, each agent initializes the parameter to participate in the training at step S110.

Subsequently, setting Jₘₐₓ, which is the maximum value of the JS-stationarity used in the embodiment at step S120, may be further performed. At step S120, the maximum value may be set in such a way that a researcher inputs the value from outside or may be set by a separate external control device in an automated manner.

Here, a value that is equal to or less than the maximum value of a stationarity that is the sum of the skewed JS-divergences, each of which is a change in the policy of each of the multiple agents, may be preassigned as the maximum value of the skewed JS-divergence stationarity. That is, according to an embodiment, the non-stationarity measurement technique is defined by calculating a change in the policy of each agent between the step at the time of t and the step at the time of t+1 as the skewed JS divergence and calculating the sum of the skewed JS divergences of the respective agents, and this is referred to as a JS-stationarity. The JS-stationarity, D_{JS}, is defined as shown in Equation (7) below:

$${D}_{JS} = {\sum }_{i = 1}^{N} {D}_{JS}^{{α}_{i}} ( {π}_{t}^{i} ‖ {π}_{t + 1}^{i} ) \qquad ( 7 )$$

In Equation (7), N is the number of agents, and i is the subscript for identifying each agent.

Subsequently, each agent is assigned max(D_{JS}^{α}^{ᵢ}), which is the maximum value of D_{JS}^{α}^{ᵢ} that does not exceed each Jₘₐₓ value.

That is, max(D_{JS}^{α}^{ᵢ}), which is the maximum value of the non-stationarity of the skewed Jensen-Shannon divergence, is initially assigned to each of the agents such that D_{JS}, which is the sum of the skewed JS-divergences of the agents, is equal to or less than Jₘₐₓ, which is a predetermined threshold. For example, when Jₘₐₓ is 10 and the number of agents is 10, each of the agents may be assigned 1 as max(D_{JS}^{α}^{ᵢ}). Accordingly, each of the agents may update the policy at or below max(D_{JS}^{α}^{ᵢ}) assigned thereto.

Referring to FIG. 2, exploring the skew parameter at step S130 may comprise setting the initial skew parameter αᵢ (i being the identifier of each agent) based on the maximum value of the skewed JS-divergence stationarity at step S131.

That is, the maximum value of the skewed JS-stationarity is defined as shown in Equation (8) below:

$${D}_{JS}^{{α}_{i}} \leq - log ( 1 - α ) \qquad ( 8 )$$

Simplifying Equation (8), the minimum value of α may be represented as shown in Equation (9) below:

$$1 - {e}^{- {D}_{JS}^{{α}_{i}}} \leq {α}_{i} \qquad ( 9 )$$

In Equation (9), because the maximum value of D_{JS}^{α}^{ᵢ} is the initial value that is set as described above, the initial value of αᵢ corresponding to the minimum value may be defined as shown in Equation (10) below:

$$1 - {e}^{- max ( {D}_{JS}^{{α}_{i}} )} = {α}_{i} \qquad ( 10 )$$

Here, referring to FIG. 2, when exploring the skew parameter at step S130, storing experience using the current policy at step S132, performing stochastic policy training based on the stored experience at step S133, and calculating the skewed JS-divergence from the previous policy using the skew parameter αᵢ at step S134 may be performed after setting the initial value of αᵢ as described above.

That is, after completion of one iteration of the stochastic policy training, the skewed JS-divergence from the previous policy is calculated. When the initially set value of αᵢ is used, it is highly probable that max(D_{JS}^{α}^{ᵢ}) is not exceeded.

Accordingly, referring to FIG. 2, exploring the skew parameter at step S130 may comprise repeatedly performing calculating the skewed JS-divergence at step S134 while changing the skew parameter αᵢ at step S136 until the skewed JS-divergence becomes equal to or greater than the maximum value of the skewed JS-divergence stationarity. That is, the value of αᵢ is repeatedly increased by Δ such that the value of D_{JS}^{α}^{ᵢ} reaches max(D_{JS}^{α}^{ᵢ}).

Subsequently, referring to FIG. 3, performing the training based on the target policy at step S140 may include setting the target policy at step S141 through interpolation between the actually trained policy and the previous policy using the skew parameter αᵢ when the skewed JS-divergence is equal to or greater than the maximum value of the skewed JS-divergence stationarity. That is, when the desired αᵢ value is found at step S130, the target policy π^{target} is found through interpolation between the actually trained policy and the previous policy as shown in Equation (11) below:

$${π}^{target} = ( 1 - α ) π + α \overline{π} \qquad ( 11 )$$

Subsequently, referring to FIG. 3, performing the training based on the target policy at step S140 may comprise performing the training such that the policy parameter of the agent approximates to the target policy at step S142 by setting a loss function to the JS-divergence between the current policy and the target policy. That is, the current policy π is approximated to π^{target} through the JS-divergence by setting the loss function as shown in Equation (12) below:

$$L = {D}_{JS} ( {π}^{t a rget} , {π}_{θ} ) \qquad ( 12 )$$

Here, referring again to FIG. 1, exploring the skew parameter at step S130 and performing the training at step S140 may be repeatedly performed a predetermined number of times.

FIG. 4 is a view illustrating a computer system configuration according to an embodiment.

The apparatus for distributed multi-agent reinforcement learning according to an embodiment may be implemented in a computer system 1000 including a computer-readable recording medium.

The computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected with a network 1080. The processor 1010 may be a central processing unit or a semiconductor device for executing a program or processing instructions stored in the memory 1030 or the storage 1060. The memory 1030 and the storage 1060 may be storage media including at least one of a volatile medium, a nonvolatile medium, a detachable medium, a non-detachable medium, a communication medium, or an information delivery medium, or a combination thereof. For example, the memory 1030 may include ROM 1031 or RAM 1032.

According to the disclosed embodiment, the occurrence of non-stationarity may be quantitatively predicted when an agent under a multi-agent reinforcement learning environment updates a policy.

Therefore, the update span may be adjusted to suppress the occurrence of non-stationarity below a certain amount. Furthermore, the occurrence of non-stationarity may be mitigated. As a result, the phenomenon of poor training resulting from the non-stationarity may be alleviated.

Although embodiments of the present disclosure have been described with reference to the accompanying drawings, those skilled in the art will appreciate that the present disclosure may be practiced in other specific forms without changing the technical spirit or essential features of the present disclosure. Therefore, the embodiments described above are illustrative in all aspects and should not be understood as limiting the present disclosure.

What is claimed is:

1. A method for distributed multi-agent reinforcement learning, comprising:
exploring a skew parameter at which a skewed Jensen-Shannon-(JS-)divergence, which is a change in a policy, becomes equal to or greater than a preassigned maximum value of a skewed JS-divergence stationarity; and
performing training based on a target policy set using the skew parameter.

2. The method of claim 1, wherein a value equal to or less than a maximum value of a stationarity that is a sum of skewed JS-divergences, each of which is a change in a policy of each of multiple agents, is preassigned as the maximum value of the skewed JS-divergence stationarity.

3. The method of claim 1, further comprising:
before exploring the skew parameter, initializing a policy parameter of an agent.

4. The method of claim 1, wherein exploring the skew parameter includes
setting an initial skew parameter αᵢ (i being an identifier of an agent) based on the maximum value of the skewed JS-divergence stationarity.

5. The method of claim 4, wherein, when exploring the skew parameter,
storing experience using a current policy, performing stochastic policy training based on the stored experience, and calculating a skewed DS-divergence from a previous policy using the skew parameter αᵢ are performed, and
calculating the skewed JS-divergence while changing the skew parameter αᵢ is repeatedly performed until the skewed JS-divergence becomes equal to or greater than the maximum value of the skewed JS-divergence stationarity.

6. The method of claim 5, wherein performing the training includes
when the skewed JS-divergence is equal to or greater than the maximum value of the skewed JS-divergence stationarity, setting the target policy through interpolation between an actually trained policy and the previous policy using the skew parameter αᵢ.

7. The method of claim 6, wherein performing the training comprises performing the training such that a policy parameter of the agent approximates to the target policy by setting a loss function to a JS-divergence between the current policy and the target policy.

8. The method of claim 1, wherein exploring the skew parameter and performing the training are repeatedly performed a predetermined number of times.

9. An apparatus for distributed multi-agent reinforcement learning, comprising:
memory in which at least one program is recorded; and
a processor for executing the program,
wherein the program performs
exploring a skew parameter at which a skewed Jensen-Shannon-(JS-)divergence, which is a change in a policy, becomes equal to or greater than a preassigned maximum value of a skewed JS-divergence stationarity, and
performing training based on a target policy set using the skew parameter.

10. The apparatus of claim 9, wherein a value equal to or less than a maximum value of a stationarity that is a sum of skewed JS-divergences, each of which is a change in a policy of each of multiple agents, is preassigned as the maximum value of the skewed JS-divergence stationarity.

11. The apparatus of claim 9, wherein the program further performs
initializing a policy parameter of an agent before exploring the skew parameter.

12. The apparatus of claim 9, wherein, when exploring the skew parameter, the program performs setting an initial skew parameter αᵢ (i being an identifier of an agent) based on the maximum value of the skewed JS-divergence stationarity.

13. The apparatus of claim 12, wherein, when exploring the skew parameter, the program
performs storing experience using a current policy, performing stochastic policy training based on the stored experience, and calculating a skewed DS-divergence from a previous policy using the skew parameter αᵢ, and
repeatedly performs calculating the skewed JS-divergence while changing the skew parameter αᵢ until the skewed JS-divergence becomes equal to or greater than the maximum value of the skewed JS-divergence stationarity.

14. The apparatus of claim 13, wherein, when performing the training, the program performs setting the target policy through interpolation between an actually trained policy and the previous policy using the skew parameter αᵢ when the skewed JS-divergence is equal to or greater than the maximum value of the skewed JS-divergence stationarity.

15. The apparatus of claim 14, wherein, when performing the training, the program performs the training such that a policy parameter of the agent approximates to the target policy by setting a loss function to a JS-divergence between the current policy and the target policy.

16. The apparatus of claim 9, wherein the program repeatedly performs exploring the skew parameter and performing the training a predetermined number of times.
